(19) United States
(12) Patent Application Publication
(10) Pub. No.: US 2003/0163573 A1
(43) Pub. Date: Aug. 28, 2003

(54) Information disclosure method and information disclosure system

(75) Inventor: Hiroshi Nojima, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/340,306

(22) Filed: Jan. 9, 2003

(30) Foreign Application Priority Data
Feb. 15, 2002 (JP) 2002-037598

(51) Int. Cl. G06F 15/16; G06F 15/173

(52) U.S. Cl. 709/228; 709/224

(57) ABSTRACT

The present invention makes it possible to define the page freshness that is required for the page information to be disclosed or auser's page information acquisition request. A cache computer and a server computer both consider the required freshness. If the freshness is adequate, a cached static page is returned immediately. If the freshness is not adequate, on the other hand, a dynamic page generation process is performed. Further, the page information in the server computer is updated independently of a user's access request.

### BACKGROUND OF THE INVENTION

The present invention relates to an information disclosure method and information disclosure system for permitting a server computer to create or select and then transmit page information in compliance with a client computer's request in an environment where computers, including a client computer and a server computer, are connected via a network.

Due to widespread use of the Internet and advance in WWW technology, the WWW page access method for transferring page information written in HTML or XML via the Internet and displaying it on a client computer has been widely used in recent years. A method for analyzing and compiling data stored in a database and disclosing it via WWW is disclosed in JP-A No. 133892/1998 “METHOD FOR PROCESSING SERVLET, AND SYSTEM THEREFOR” (Corresponding U.S. Pat. No. 5,928,323).

### SUMMARY OF THE INVENTION

When the above prior art is used, however, the contents of generated page information are lost when it is transmitted to a client. Creating page information upon each request from a client imposes a burden on a server, making it difficult to increase the responsiveness to clients. To solve this problem, a system can be configured so as to allow a server to periodically access a database to create static pages and prevent the database from being accessed when a client accesses the server. When the system is configured in this manner, it can enhance the responsiveness to users and minimize the load on the server.

In a system where pages are periodically created by a server and distributed in compliance with user requests, its responsiveness is excellent but distributed pages are not up-to-date. As a result, the distributed pages may not always meet the needs of users.

In a system where pages are created upon a user's request, database access and page generation occur each time after the receipt of a user's request. As a result, the load on a server increases, rendering the responsiveness to users persistently lower than when static pages are distributed.

As described above, it is difficult for the conventional method to enhance the responsiveness to users and reduce the server load while transmitting pages to meet the needs of users.

It is therefore an object of the present invention to provide an information disclosure method and information disclosure system, which make it possible to judge the presence or absence of the necessity for page generation by judging whether the elapsed time from the page generation time is user-tolerable, and distribute pages to meet the needs of users while minimizing the server load.

To provide pages in compliance with the needs of users, the present invention provides means for predefining a demanded freshness, which is the page freshness necessary for page access requests from users. The present invention also makes it possible to define a user-specific required freshness for disclosing the page information on a WWW server. When a page is accessed, the present invention compares the time elapsed from the page generation time with the demanded freshness and required freshness to check for the necessity of page generation, and determines whether to distribute a previously generated page or generate a new page for distribution.

By using a combination of demanded freshness and required freshness concerning page access in the above manner to check for the necessity of page generation and newly generate only a required page, the present invention can distribute a page in compliance with the needs of users while keeping the server load lower than the prior art.

### BRIEF DESCRIPTION OF THE DRAWINGS

FIG. 1 is a system configuration diagram depicting an information disclosure method of the present invention;

FIG. 2 is a diagram showing a cache computer's typical page management table that is used in a cache management processing unit;

FIG. 3 is a diagram showing a server computer's typical user management table that is used in a page selection processing unit;

FIG. 4 is a diagram showing a server computer's typical page management table that is used in a page selection processing unit;

FIG. 5 is a flowchart depicting the process of a cache management processing unit;

FIG. 6 is a flowchart depicting the process that a page selection processing unit performs to generate a page upon a user's request; and

FIG. 7 is a flowchart depicting the process that a page automatic update processing unit performs to generate a page independently of a user's request.

### DESCRIPTION OF THE PREFERRED EMBODIMENTS

Preferred embodiments of the present invention will now be described in detail with reference to the accompanying drawings.

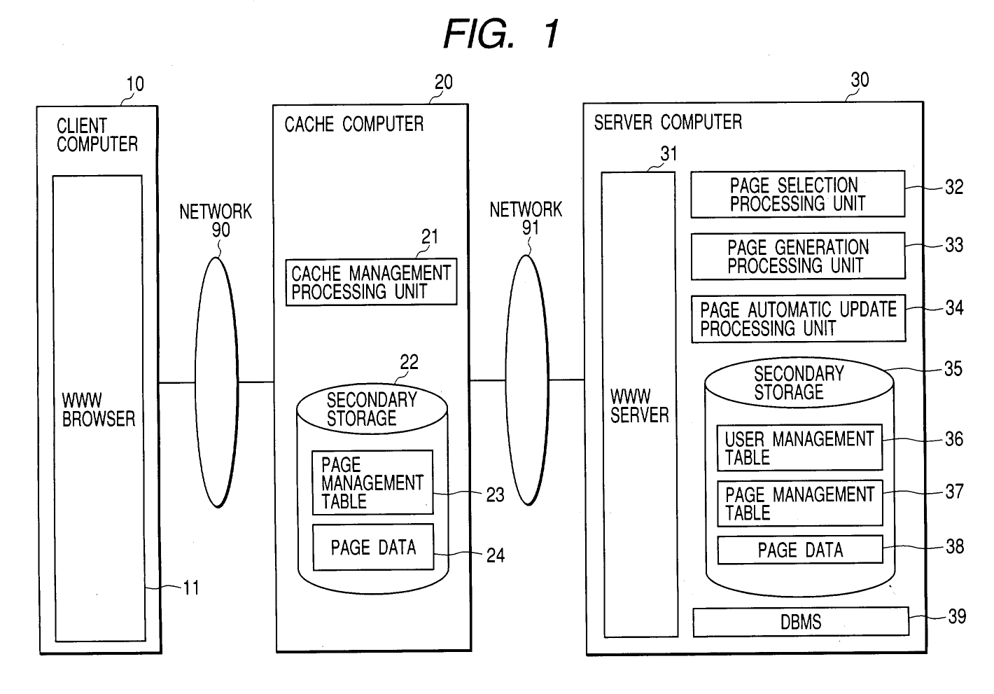

FIG. 1 is a system block diagram that shows a configuration of the present invention when it comprises a client computer, a cache computer, and a server computer. The client computer 10, cache computer 20, and server computer 30 are interconnected via networks.

On the client computer 10, a WWW browser 11 runs as a viewer that the users use to acquire and view page information. Although the present embodiment assumes that the users use a WWW browser as a viewer, the present invention remains effective when a viewer other than a browser is used. The client computer 10, cache computer 20, and server computer 30 are equipped each with a storage device for storing one or more programs, and the respective processors perform processing operations in accordance with the stored programs. Further, these computers are provided each with a device for connecting to a network.

The cache computer 20 includes a cache management processing unit 21 and a secondary storage 22. A major role of the cache computer 20 is to cache the page information for transfer from the server computer 30 to the client computer 10 so that whenever two or more client computers issue a request for accessing the same page, the cache computer 20 can return the cached page to the client computers without making a request to the server computer for the latest page information. The secondary storage 22 stores a page management table 23 for managing a list of cached pages, and page data 24, which are the real data about cached pages. Under normal conditions, a large number of page data 24 exist. The page management table 23 will be described in detail later. The present invention is also applicable to a system configuration from which the cache computer 20 is removed due to cost or user request considerations.

The server computer 30 comprises a WWW server 31, a page selection processing unit 32, which responds to a page acquisition request received via the WWW server by determining whether the server computer 30 should return a previously generated page stored in a secondary storage or generate a new page, a page generation processing unit 33 for performing a new-page generation process, a secondary storage 35, and a DBMS 39. The secondary storage 35 stores a user management table 36, a page management table 37, and page data 38 that are cached data about previously generated pages. The table information will be described in detail later. The DBMS 39 stores the data that the page generation processing unit references at the time of page generation. Although the DBMS 39 is positioned within the server computer 30 in the present embodiment, it may alternatively be placed within a DBMS server other than the server computer 30.

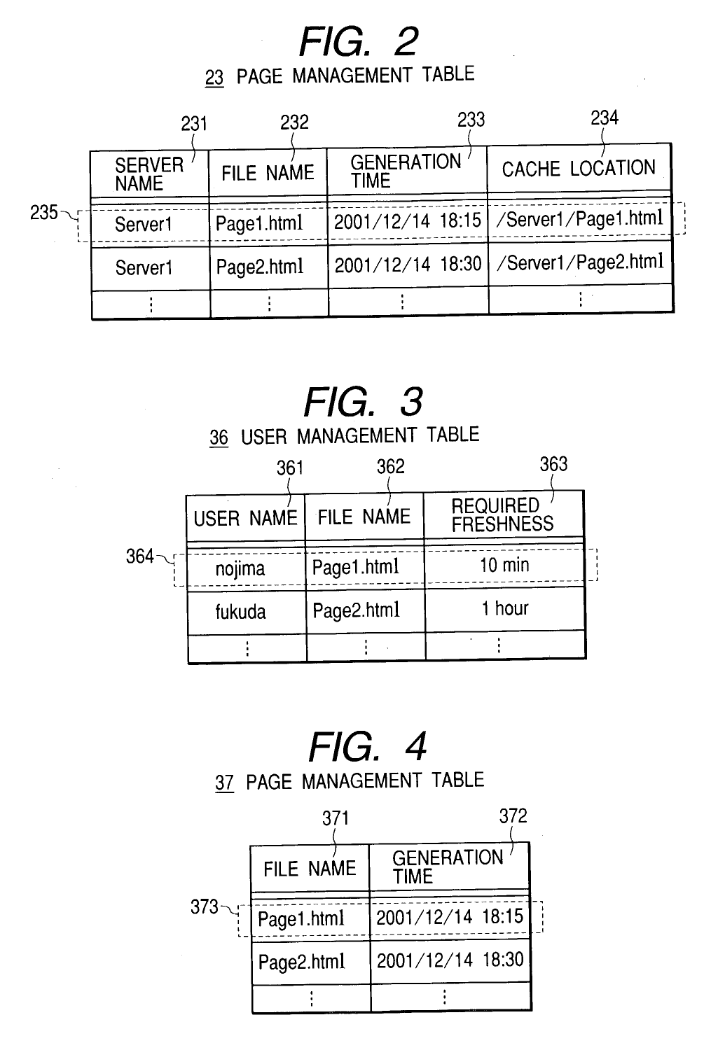

The structures of the tables used in the present embodiment will now be described with reference to FIGS. 2 to 4. The field structures indicated in these figures are merely examples. Tables having a field structure different from those indicated in the figures will be readily adapted for use with the present invention.

FIG. 2 shows the structure of the page management table 23, which is used in the cache management processing unit 21 of the cache computer 20. This table 23 has four fields, which respectively carry a server name 231 for indicating which storage location in which server a cached file is acquired from, a file name 232, a generation time 233 for indicating the time of generation within the server computer, and a cache location 234 for indicating the storage location of page data 24 in the secondary storage 22. Each time the page data 24 is cached in the cache computer 20, a new record is added. Each time the page data 24 is updated with new page information, the record generation time 233 is updated.

FIG. 3 shows the structure of the user management table 36, which is used in the page selection processing unit 32 and page automatic update processing unit 34 of the server computer 30. This table 36 has three fields, which respectively carry a user name 361 for indicating the names of users authorized to access a page, a file name 362 for indicating the file name for the page stored in the secondary storage 35, and a required freshness 363 for indicating the freshness required for offering the page to a user. As regards the user name 361, one record need not always be furnished for each user. Alternatively, a group name may be assigned to a separately defined group of users. The required freshness 363 indicates the page distribution time limit that should not be exceeded by the difference between the page generation time and the user's access time. If the required freshness is 0, it means that page generation is always needed for each access.

FIG. 4 shows the structure of the page management table 37, which is used in the page selection processing unit 32 and page automatic update processing unit 34 of the server computer 30. This table 37 has two fields, which respectively carry a file name 371 for indicating the path to a page stored in secondary storage 35 and a generation time 372 for indicating the time at which the page was generated.

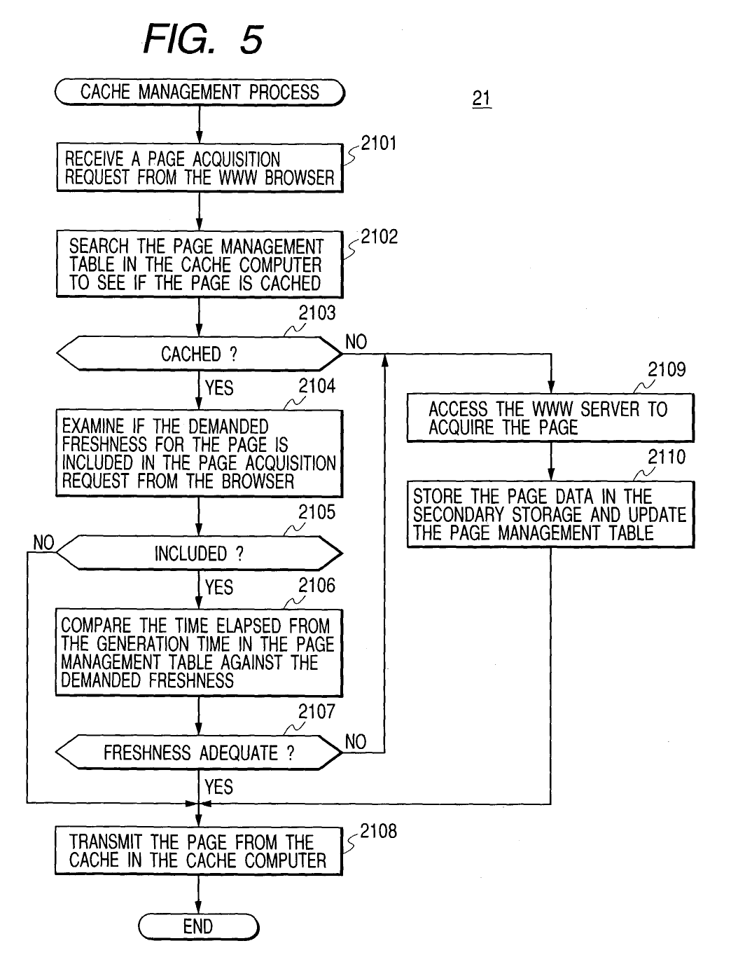

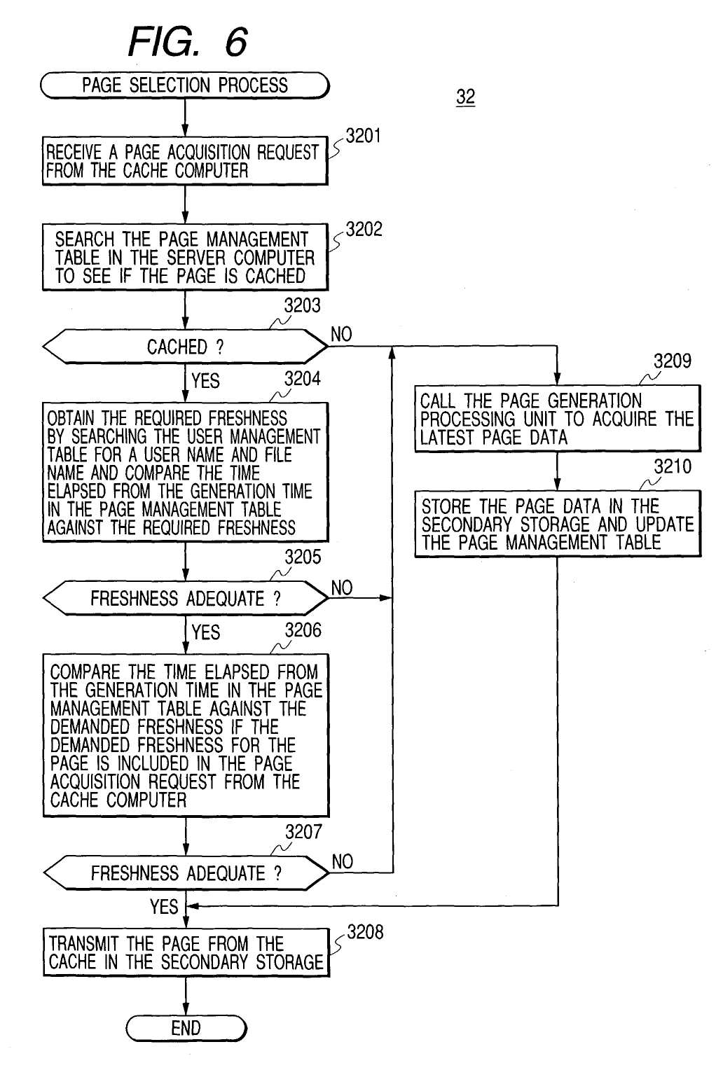

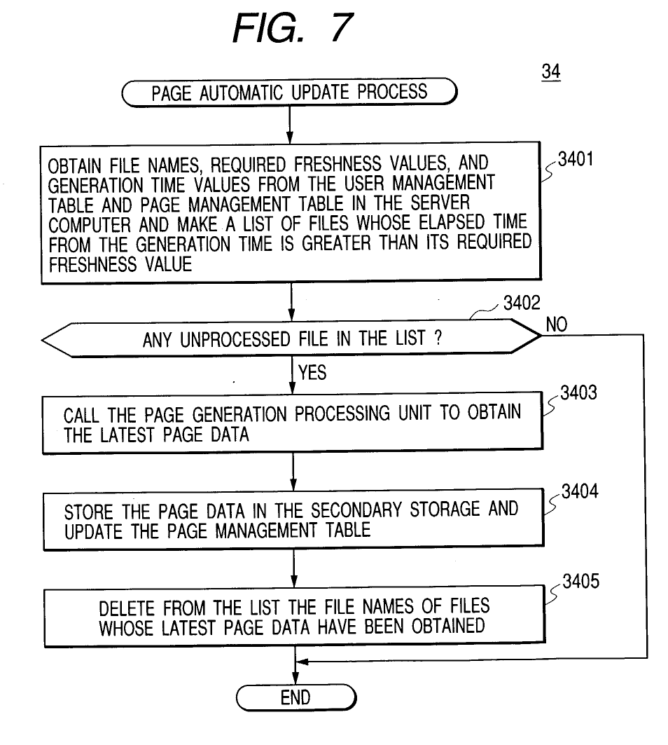

The flowcharts in FIGS. 5 to 7 indicate the processing steps related to the present invention. FIG. 5 shows the process that is performed by the cache management processing unit 21 of the cache computer 20. FIG. 6 shows the process that is performed by the page selection processing unit 32 of the server computer 30. FIG. 7 shows the process that is performed by the page automatic update processing unit 34 of the server computer 30.

The flowchart in FIG. 5 will now be used to describe the processing steps that the cache management processing unit 21 performs when a user acquires a page from a WWW browser 11 for browsing purposes.

In step 2101, a request for page acquisition is received from the WWW browser 11. In the next step 2102, the page management table 23 on the cache computer 20 is searched with a server name 231 and file name 232 used as the search keys in order to check whether the requested page is cached in the secondary storage 22. If the requested page is not cached, step 2109 is performed next (step 2103).

If the requested page is cached, in step 2104, it is checked whether the demanded freshness for the requested page is included in the page acquisition request from the WWW browser 11. If the demanded freshness is not included, step 2108 is performed next (step 2105).

If the demanded freshness is included, in step 2106, the time elapsed from the generation time 233 indicated in the page management table 23 is calculated and the calculated elapsed time is compared with the demanded freshness. If the demanded freshness value is smaller than the calculated elapsed time value, the cached page is older than requested by the user. In this instance, step 2109 is performed next in order to acquire new page information from the server computer 30 (step 2107).

If the demanded freshness value is greater than the calculated elapsed time value, on the other hand, the cached page is newer than requested by the user. In this instance, the user's request can be answered by returning the page cached in the cache computer 20. Therefore, the page data 24 designated in the field of cache location 234 is transmitted to the WWW browser to end the cache management process (step 2108).

If the requested page is not cached or the cached page data is older than requested by the user, the server computer 30 is requested to generate a new page. In step 2109, the WWW server 31 is accessed to acquire the new page. The internal process of the WWW server 31 will be described later. The next step 2110 is then performed to store the acquired page data in the secondary storage 22 and update the page management table 23. Subsequently, the page data is transmitted to the WWW browser 11 to end the cache management process (step 2108). To enhance the responsiveness to the WWW browser, the page data may alternatively be transmitted to the WWW browser 11 prior to step 2110.

The flowchart in FIG. 6 will now be used to describe the processing steps that the page selection processing unit 32 performs upon receipt of a page acquisition request from the cache computer 20.

In step 3201, a page acquisition request is received from the cache computer 20. In the next step 3202, the page management table 37 on the server computer 30 is searched with a file name 371 used as the search key in order to check whether the requested page is cached in the secondary storage 35. If the requested page is not cached, step 3209 is performed next (step 3203).

If the requested page is cached, in step 3204, the user management table 36 is searched with a user name 361 and file name 362 used as the search keys to acquire the required freshness. The time elapsed from the generation time 372 indicated in the page management table 37 is calculated and then compared with the required freshness. If the required freshness value is smaller than the calculated elapsed time value, the cached page is too old for the requesting user. Therefore, step 3209 is performed next in order to acquire new page information from the page generation processing unit 33 (step 3205).

If the required freshness value is greater than the calculated elapsed time value, on the other hand, the cached page is fresh enough for disclosure to the requesting user. Therefore, the demanded freshness is confirmed subsequently. In step 3206, it is checked whether the demanded freshness for the page is included in the page acquisition request from the cache computer 20. If the demanded freshness is not included, it is concluded that the freshness is adequate. If the demanded freshness is included, on the other hand, the time elapsed from the generation time 372 indicated in the page management table 37 is calculated to compare the elapsed time with the demanded freshness. If the demanded freshness value is smaller than the elapsed time value, the cached page is older than requested by the user. Therefore, step 3209 is performed next in order to acquire new page information from the page generation processing unit 33 (step 3207).

If the demanded freshness value is greater than the elapsed time value, the cached page is newer than requested by the user. In this instance, the user's request can be answered by returning the page cached in the secondary storage 35. The page data 38 designated by a file name 371 in the page management table 35 is therefore transmitted to the cache computer 20 via the WWW server 31. The page selection process is then ended (step 3208).

If the page fails to comply with either the required freshness or the demanded freshness, the page generation processing unit 33 is called in step 3209 to acquire the generated latest page data. In step 3210, then the acquired page data is stored in the secondary storage 35 and the page management table 37 is updated. Subsequently, the page data is transmitted to the cache computer 20 via the WWW server 31 to end the page selection process (step 3208). To enhance the responsiveness of the WWW server 31, the page data may alternatively be returned to the WWW server 31 prior to step 3210.

If the employed system configuration does not include the cache computer 20, the cache computer 20 is replaced by the WWW browser 11; however, such a system configuration will be readily adapted for use with the present invention.

The flowchart in FIG. 7 will now be used to describe the processing steps that the page automatic update processing unit 34 performs to update page data 38 in the secondary storage 35 of the server computer 30 independently of access via the WWW server 31. When a page update is actively performed within the server computer 30, the responsiveness to access from the cache computer 20 or WWW browser 11 can be enhanced.

In step 3401, the user management table 36 and page management table 37 of the server computer 30 are comprehensively searched for a file name 362 and file name 371 to acquire a file name, required freshness 363, and generation time 372. If the user management table 36 contains two or more records having the same file name 362 and a plurality of required freshness values, the smallest required freshness value should be selected. Then, a list of files whose elapsed time from the generation time 372 is greater than the value of the required freshness 363 is prepared.

In step 3402, the prepared file list is checked for unprocessed files. When no unprocessed file remains in the list, the page automatic update process ends. If any unprocessed file is left, steps 3403 and beyond are performed.

In step 3403, the page generation processing unit 33 is called to acquire new page data. In step 3404, the acquired page data is stored in the secondary storage 35 and the page management table 37 is updated. After deleting the associated file name from the prepared file list, the process returns to step 3402.

As described above, the present embodiment introduces the demanded freshness and required freshness data into page management by a cache computer and server computer, making it possible to distribute page data in compliance with user-specific freshness requirements while reducing the load on a server computer and providing increased responsiveness.

What is claimed is:

1. An information disclosure method for transmitting page information, which is a unit of computer display data, to a requester in compliance with a page acquisition request, said method comprising the steps of:
calculating a difference between a user's access time and a page generation time as freshness;
receiving information for identifying page information specified by said user and demanded freshness for said specified page information; and
selecting the page information corresponding to said identifying information from a cache or newly generating page information in accordance with said demanded freshness.

2. The information disclosure method according to claim 1, wherein in said selection or new generation step the page information specified by said user is selected from said cache when said specified demanded freshness is greater than a predefined period of time.

3. The information disclosure method according to claim 2, wherein in said selection or new generation step the page information specified by said user is newly generated when said specified demanded freshness is smaller than a predefined period of time.

4. The information disclosure method according to claim 1, wherein in said selection or new generation step the page information specified by said user is newly generated when said specified demanded freshness is smaller than a predefined period of time.

5. The information disclosure method according to claim 1, further comprising the step of receiving said demanded freshness from said user.

6. The information disclosure method according to claim 1, further comprising the step of specifying said demanded freshness for each of said page information and information including said page information.

7. An information disclosure system for transmitting page information, which is a unit of computer display data, to a requester in compliance with a page acquisition request, said system comprising:
means for calculating a difference between a user's access time and a page generation time as freshness;
means for receiving information for identifying page information specified by said user and the demanded freshness for said specified page information; and
means for selecting the page information corresponding to said identifying information from a cache or newly generating page information in accordance with said demanded freshness.

8. The information disclosure system according to claim 7, wherein said selection or new generation means selects the page information specified by said user from said cache when said specified demanded freshness is greater than a predefined period of time.

9. The information disclosure system according to claim 8, wherein said selection or new generation means newly generates page information specified by said user when said specified demanded freshness is smaller than a predefined period of time.

10. The information disclosure system according to claim 6, wherein said selection or new generation means newly generates page information specified by said user when said specified demanded freshness is smaller than a predefined period of time.

11. The information disclosure system according to claim 6, further comprising means for receiving said demanded freshness from said user.

12. The information disclosure system according to claim 7, further comprising means for specifying said demanded freshness for each of said page information and information including said page information.

13. An information disclosure unit connected via a network to a client computer for transmitting a request for acquiring page information, which is a unit of computer display data, and a cache computer for storing page information to be disclosed upon an acquisition request, said unit comprising:
a connection device connected to said network for the purpose of receiving a page information access request from a user of said client computer;
a storage device for storing a program; and
a processor connected to said storage device for the purpose of comparing a time of access via said connection device with a page generation time to calculate a time difference of the page information designated by aid access request as freshness in compliance with said program, detecting information for identifying the user-specified page information from said received access request and demanded freshness for said specified page information, and selecting the page information corresponding to said identifying information from said cache computer or newly generating page information in accordance with said demanded freshness.

14. The information disclosure unit according to claim 13, wherein said processor selects page information specified by said user from said cache computer when said specified demanded freshness is greater than a predetermined period of time, and transmits via said connection device information for instructing said cache computer to present said page information specified by said client computer.

15. The information disclosure unit according to claim 14, wherein said processor newly generates page information specified by said user and presents said newly generated page information via said connection device when said specified demanded freshness is smaller than a predetermined period of time.

16. The information disclosure unit according to claim 13, wherein said selection or new generation means newly generates page information specified by said user when said specified demanded freshness is smaller than a predetermined period of time.
